(19) United States
(12) Patent Application Publication
(10) Pub. No.: US 2008/0148843 A1
(43) Pub. Date: Jun. 26, 2008

(54) Integrated thermostat overmolded leadwire construction

(75) Inventors: Colin Drummond, Glasgow (GB); Vipin J. Pillai, Bellshill (GB)

Correspondence Address: Bryan Anderson, Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/590,064

(22) Filed: Oct. 31, 2006

(51) Int. Cl. G01F 15/00

(52) U.S. Cl. 73/276

(57) ABSTRACT

A system and method for the integration of lead frame technology within an electro-mechanical switching device. An integrated thermostat system can be formed, which includes a lead frame substrate, at least one electro-mechanical lead frame configured upon said lead frame substrate, and an electro-mechanical switching device associated with the electro-mechanical lead frame, wherein the electro-mechanical lead frame is integrated with said electro-mechanical switching device within said electro-mechanical switching device. A thermal response component is generally associated with said electro-mechanical switching device

### TECHNICAL FIELD

Embodiments are generally related to electromechanical thermostats. Embodiments are also related to integrated thermostats. Embodiments are additionally related to lead frame components.

### BACKGROUND OF THE INVENTION

Many processes and devices have been used for integrating thermostats in electro-mechanical devices and space temperature control situations. Thermostat control devices are often utilized in heating and cooling systems in buildings, homes, and industrial applications such as power plants. Thermostat control devices are required, for example, to control power to a furnace or air conditioner blower motor, which is typically an AC induction motor. In heating, ventilation and air-conditioning (HVAC) systems, such as home air conditioning systems, it is often desirable to change the fan speed or blower speed to control the amount of airflow through the system's evaporator coil.

Thermostats are universally present in dwellings and other temperature-controlled spaces. Therefore it is desirable to maintain different temperatures in varying areas of a structure. Thermostats usually come in a variety of shapes and with a variety of functions. All thermostats do, however, share the feature of having some means for adjusting the temperature set point. Thermostats with temperature setting knobs, for example are usually (but not always) round. Another class of thermostats involves devices whose settings are lever-controlled. These types of thermostats are typically rectangular in shape. It is generally true that it is easier to implement a larger number of auxiliary functions with a rectangular-shaped thermostat.

Thermostats are typically of two types, electronic and electro-mechanical. While electronic thermostats offer more features, they are also more expensive, and their more complicated user interface tends to confuse technically challenged individuals. Accordingly, there remains a substantial market for electro-mechanical thermostats. Simple electro-mechanical thermostats typically possess a bimetal coil with a free end whose angular orientation controls the temperature setting, usually by shifting the angle of a mercury bulb switch. Electro-mechanical thermostats usually include a temperature sensing element that responds mechanically to temperature changes. A number of electrical switching applications require mechanical switches that are both efficient and reliable. These requirements arise commonly in electro-mechanical thermostats utilized in the thermostat control of heating and cooling systems in homes and buildings as indicated above.

Lead frames for semiconductor packages are used for packing semiconductor chips to form electronic devices in housings, typically constructed of a plastic compound. Such lead frame based devices must satisfy high reliability despite their mass production. Such packages can be made very thin because the leads are exposed at the bottom surface of an encapsulated material. Moreover, the packages are reliable because encapsulated material is provided under one or more portions of the leads, thereby locking the leads to a package body of encapsulated material. Further, encapsulated material can be provided under a peripheral lip of a chip pad, upon which the chip is mounted, thereby locking the chip pad to the encapsulated material.

It is believed that a need exists to improve electromechanical thermostats by providing increasingly smaller package configurations with enhanced usability and reliability. By providing the integration of lead frame technology within an electromechanical switching device, which has not been implemented in the prior art, it is believed that enhanced product performance, reduced manufacturing variability, improved in-service reliability and increased process flexibility can be attained.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved electromechanical thermostat.

It is another aspect of the present invention to provide for an integrated thermostat.

It is a further aspect of the present invention to provide for an improved overmolded lead wire construction.

The aforementioned aspects and other objectives and advantages can now be achieved as described herein. A system and method for the integration of lead frame technology within an electro-mechanical switching device is disclosed. An integrated thermostat system can be formed, which includes a lead frame substrate, at least one electro-mechanical lead frame configured upon said lead frame substrate, and an electro-mechanical switching device associated with the electro-mechanical lead frame, wherein the electro-mechanical lead frame is integrated with said electro-mechanical switching device within said electro-mechanical switching device.

A thermal response component is generally associated with said electro-mechanical switching device, such that the thermal response component comprises a single component configured preferably in the form of a live hinge. Alternatively, the thermal response component may comprise a sub-assembly of thermal response components. The lead frame substrate is preferably electrically insulated. Additionally, the electro-mechanical lead frame can be configured as a single entity or may form part of a continuous conductive strip cropped to achieve and appropriate electrical circuit.

The basic element package includes one or more lead frames and an overmolded substrate. Enhanced product performance can be achieved from fewer electrical connections that produce a lower switch resistance and an improved shock bump with enhanced vibration performance. Reduced manufacturing variability can also be attained by the use of an optimized component quantity that shortens the spread of the dimensional tolerance “stack up”. The minimized parts count equates to higher reliability and improves in-service reliability. The reduced process set up and configuration times in the resulting device are due to the integration of lead frame technology within an electro-mechanical switching device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of an integrated thermostat overmolded lead wire system, which can be implemented in accordance with a preferred embodiment;

FIG. 2 illustrates a block diagram of a system for an integrated thermostat overmolded lead wire construction, which can be implemented in accordance with a preferred embodiment; and

FIG. 3 illustrates a high-level flow chart of operations of an integrated thermostat overmolded lead wire construction method, in accordance with a preferred embodiment.

### DETAILED DESCRIPTION

The particular values and configurations discussed in these non-limiting examples can be varied and are cited merely to illustrate at least one embodiment and are not intended to limit the scope thereof.

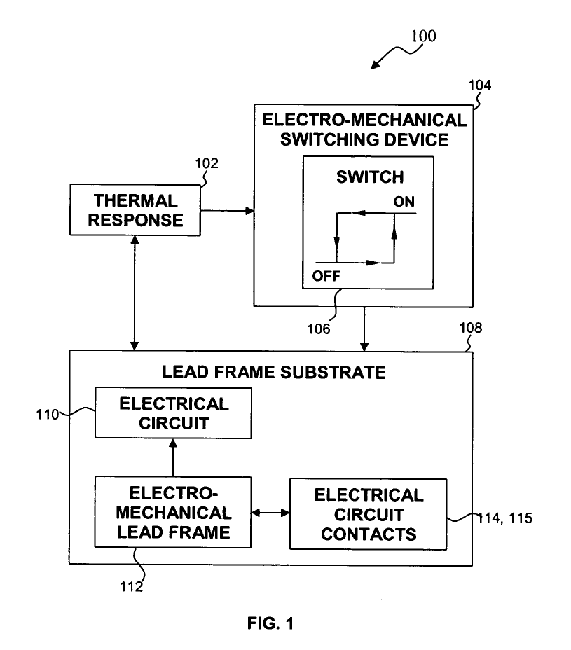

Referring now to the drawings and in particular FIG. 1, illustrates a block diagram of an integrated thermostat overmolded lead wire device or system 100, which can be implemented in accordance with a preferred embodiment. The system depicted in FIG. 1 includes a thermal response component 102 that is connected to an electromechanical switching device 104 and a lead frame substrate 108. A switch 106 associated with the electro-mechanical switching device 104 can be configured in association with the lead frame substrate 108. The thermal response component 102 is generally linked to the lead frame substrate 108. The lead frame substrate 108 generally includes the electromechanical lead frame 112 and can be connected to an electrical circuit 110. The electromechanical lead frame 112 can also operate in association with the electrical circuit one or more contacts 114, 115. That is, the electro-mechanical lead frame 112 communicates with the electrical circuit contacts 114, 115.

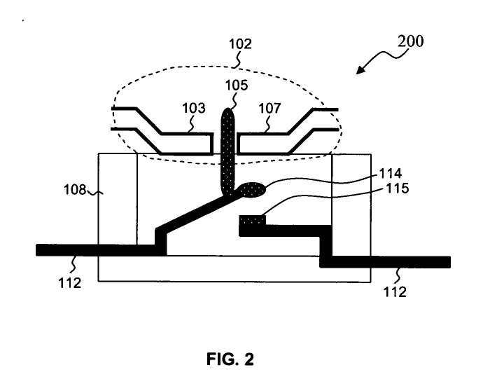

FIG. 2 illustrates a block diagram of an integrated thermostat overmolded lead wire device or system 200, which can be implemented in accordance with a preferred embodiment. Note that in FIGS. 1-2, identical or similar parts or elements are generally indicated by identical reference numerals. As indicated in FIG. 2, the thermal response component 102 is attached to the lead frame substrate 108. Note that the thermal response component 102 can be configured from one or more thermal response elements 103, 107 and 105. Thermal response element 105, for example, can be located between the thermal response elements 103, 107, depending upon design considerations. The thermal response component 102 can thus be implemented as a single component such as, for example, thermal response element or a sub-assembly of thermal response components including elements 103, 107 and/or 105.

The lead frame substrate 108 can be implemented with an electrically insulated structural entity that provides the required encapsulation. The lead frame substrate 108 provides the basic substrate upon which the electro-mechanical lead frame 112 is placed in association with the electrical circuit contacts 114, 115.

The electro-mechanical lead frame 112 can be assembled for enabling the electrical circuit contacts 114, 115, which can be implemented as traditional staked contacts or may be welded to the lead frame. Alternatively, the electrical circuit contacts 114, 115 can be homogenous to the electro-mechanical lead frame 112. Note that the electro-mechanical lead frame 112 can be provided in the form of a single entity or component or may form part of a continuous conductive strip cropped to achieve an appropriate electrical circuit, depending upon design considerations.

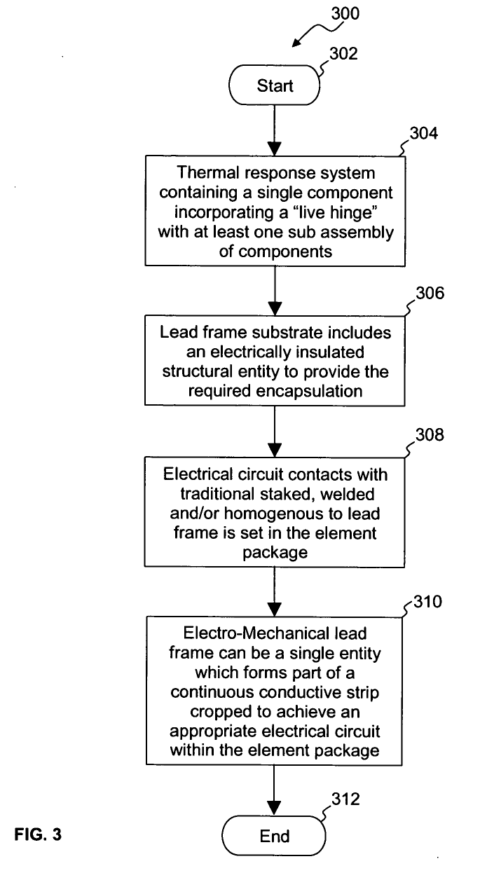

FIG. 3 illustrates a high-level flow chart 300 of operations depicting a method for integrated thermostat overmolded lead wire construction, in accordance with a preferred embodiment. The method depicted in flow chart 300 of FIG. 3 can be implemented in order to configure the system 200 depicted in FIG. 2. As depicted at block 302, the process begins. The operation depicted at block 302 generally indicates that preliminary steps may be necessary to prepare the lead frame substrate 108 and components such as the electro-mechanical lead frame 112 prior to actual assembly. Next, as indicated at block 304, the thermal response component 102 can be implemented as a single component incorporating a “live hinge” or a sub assembly of components for the resulting device or system 200.

Thereafter as described at block 306 the lead frame substrate 108 can be provided in the form of an electrically insulated structural entity that promotes the required/desired encapsulation. Next, as depicted at block 308, the electrical circuit contacts 114, 115 can be configured as traditional staked contacts or may be welded to the lead frame 112. Alternatively, the contacts 114 can be configured in a manner that makes them homogeneous to the lead frame 112. Finally, as indicated at block 310 electro-mechanical lead frame 112 can be configured in the context of a single entity that forms a part of a continuous conductive strip cropped to achieve an appropriate electrical circuit within the element package or system 200. The process can then terminate as indicated at block 312.

In general, basic element package includes one or more lead frames 112 and the overmolded substrate 108. Enhanced product performance can be achieved from fewer electrical connections that produce a lower switch resistance and an improved shock bump with enhanced vibration performance. Reduced manufacturing variability can also be attained by through the use of an optimized component quantity that shortens the spread of the dimensional tolerance “stack up”. The minimized parts count equates to higher reliability and improves in-service reliability. The reduced process set up and configuration times in the resulting device are due to the integration of lead frame technology within an electro-mechanical switching device such as the device or system 100/200 described earlier.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A integrated thermostat system, comprising:
a lead frame substrate;
at least one electro-mechanical lead frame configured upon said lead frame substrate; and
an electro-mechanical switching device associated with said at least one electro-mechanical lead frame, wherein said at least one electro-mechanical lead frame is integrated with said electro-mechanical switching device within said electro-mechanical switching device in order to provide an integrated thermostat system having a reduced manufacturing variability, an enhanced product performance, an improved in-service reliability and an increased process flexibility.

2. The system of claim 1 further comprising a thermal response component associated with said electro-mechanical switching device.

3. The system of claim 2 wherein said thermal response component comprises a single component comprising a live hinge.

4. The system of claim 2 wherein said thermal response component comprises a sub-assembly of thermal response components.

5. The system of claim 1 wherein said lead frame substrate is electrically insulated.

6. The system of claim 1 wherein said at least one electro-mechanical lead frame constitutes a single entity.

7. The system of claim 1 wherein said at least one electro-mechanical lead frame comprises a continuous conductive strip cropped to achieve an appropriate electrical circuit.

8. An integrated thermostat system, comprising:
a lead frame substrate;
at least one electro-mechanical lead frame configured upon said lead frame substrate;
an electro-mechanical switching device associated with said at least one electro-mechanical lead frame; and
a thermal response component associated with said electro-mechanical switching device wherein said at least one electro-mechanical lead frame is integrated with said electro-mechanical switching device within said electro-mechanical switching device in order to provide an integrated thermostat system having a reduced manufacturing variability, an enhanced product performance, an improved in-service reliability and an increased process flexibility.

9. The system of claim 8 wherein said thermal response component comprises a single component comprising a live hinge.

10. The system of claim 8 wherein said thermal response component comprises a sub-assembly of thermal response components.

11. The system of claim 8 wherein said lead frame substrate is electrically insulated.

12. The system of claim 8 wherein said at least one electro-mechanical lead frame constitutes a single entity.

13. The system of claim 8 wherein said at least one electro-mechanical lead frame comprises a continuous conductive strip cropped to achieve an appropriate electrical circuit.

14. An integrated thermostat method, comprising:
providing a lead frame substrate;
configuring at least one electro-mechanical lead frame upon said lead frame substrate; and
associating an electro-mechanical switching device with said at least one electro-mechanical lead frame, wherein said at least one electro-mechanical lead frame is integrated with said electro-mechanical switching device within said electro-mechanical switching device in order to provide an integrated thermostat system having a reduced manufacturing variability, an enhanced product performance, an improved in-service reliability and an increased process flexibility.

15. The method of claim 14 further comprising associating a thermal response component with said electro-mechanical switching device.

16. The method of claim 15 wherein said thermal response component comprises a single component comprising a live hinge.

17. The method of claim 15 wherein said thermal response component comprises a sub-assembly of thermal response components.

18. The method of claim 14 wherein said lead frame substrate is electrically insulated.

19. The method of claim 14 wherein said at least one electro-mechanical lead frame constitutes a single entity.

20. The method of claim 14 wherein said at least one electro-mechanical lead frame comprises a continuous conductive strip cropped to achieve an appropriate electrical circuit.
